(19) United States
(12) Patent Application Publication
(10) Pub. No.: US 2021/0114021 A1
(43) Pub. Date: Apr. 22, 2021

(54) MAGNETICALLY ACTUATED SURFACES FOR DYNAMIC IRIDESCENCE

(71) Applicant: North Carolina State University, Raleigh, NC (US)

(72) Inventors: Chih-Hao Chang, Austin, TX (US); Zhiren Luo, Austin, TX (US)

(21) Appl. No.: 17/073,702

(22) Filed: Oct. 19, 2020

Related U.S. Application Data
(60) Provisional application No. 62/923,305, filed on Oct. 18, 2019.

(51) Int. Cl. B01L 3/00; H01F 1/44

(52) U.S. Cl. CPC B01L 3/50273; B01L 3/502715; B82Y 30/00; B03C 2201/18; B01L 2400/043; H01F 1/445

(57) ABSTRACT

Various examples are provided related to surfaces that can achieve controllable dynamic iridescence. In one example, a magnetically actuated surface includes an array of magnetic nanopillars; and a ferrofluid sealed in a microfluidic channel over the array of magnetic nanopillars. In another example, a method for forming a magnetically actuated surface includes generating a 2D periodic array of recesses in a photoresist layer; generating a nanopillar template from the 2D periodic array of recesses in the photoresist layer; forming a microfluidic channel over the nanopillar template; and filling the microfluidic channel with a ferrofluid comprising magnetic nanoparticles in a fluid medium.

### CROSS REFERENCE TO RELATED APPLICATIONS

This application claims priority to, and the benefit of, co-pending U.S. provisional application entitled “Magnetically Actuated Surfaces for Dynamic Iridescence” having Ser. No. 62/923,305, filed Oct. 18, 2019, which is hereby incorporated by reference in its entirety.

### BACKGROUND

Coloration in nature is primarily based on two mechanisms: pigmentary coloration ascribed to chemical dyes that absorb light within a narrow wavelength band, and structural coloration caused by the interference of visible light in periodic micro- and/or nanostructures. Structural coloration can create iridescent behaviors, where the colors gradually change as incident or viewing angles are varied, or non-iridescent behaviors, where certain colors are reflected evenly at broad viewing angles.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate an example of photonic structures and mechanism of dynamic iridescence, in accordance with various embodiments of the present disclosure.

FIGS. 2A-2F illustrate an example of the fabrication of a magnetically actuated surface, in accordance with various embodiments of the present disclosure.

FIG. 3 includes scanning electron microscope (SEM) images of a fabricated ferrofluid polydimethylsiloxane (FFPDMS) template, in accordance with various embodiments of the present disclosure.

FIGS. 4A-4D illustrate tilt actuation characterization of FFPDMS pillars, in accordance with various embodiments of the present disclosure.

FIGS. 5A-5D illustrate an example of refection efficiency measurement, in accordance with various embodiments of the present disclosure.

FIGS. 6A-6D illustrate examples of iridescence demonstration using spectrometry and camera images, in accordance with various embodiments of the present disclosure.

FIGS. 7A and 7B illustrate magnetic properties of FFPDMS, in accordance with various embodiments of the present disclosure.

FIGS. 8A and 8B illustrate the characterization of the iron oxide nanoparticles in ferrofluid, in accordance with various embodiments of the present disclosure.

FIG. 9 are microscopy images of the disassembly process when the external field is removed, in accordance with various embodiments of the present disclosure.

FIG. 10 illustrates an example of a magnetic field distribution contour of a permanent magnet, in accordance with various embodiments of the present disclosure.

FIGS. 11A and 11B illustrate the magnetic field along z axis above the permanent magnet, in accordance with various embodiments of the present disclosure.

FIGS. 12A and 12B illustrate examples of magnetic forces, in accordance with various embodiments of the present disclosure.

FIG. 13 is an image of an example of SACs on PDMS pillar array under out-of-plane magnetic field, in accordance with various embodiments of the present disclosure.

FIG. 14 illustrates examples of degradation of SACs at large tilt angles, in accordance with various embodiments of the present disclosure.

FIGS. 15A and 15B illustrate the relationship between incident angle and reflection angle for the +1st, −1st, and 0th orders, in accordance with various embodiments of the present disclosure.

FIGS. 16A and 16B illustrate examples of 2D contour of reflection efficiency with different incident angles, in accordance with various embodiments of the present disclosure.

FIGS. 17A-17D illustrate examples of spectrometry measurement and spectra, in accordance with various embodiments of the present disclosure.

FIG. 18 illustrates an example of a multilayer reflector, in accordance with various embodiments of the present disclosure.

### DETAILED DESCRIPTION

Disclosed herein are various examples related to surfaces that can achieve controllable dynamic iridescence. The disclosed adaptive nanostructured films can be placed on arbitrary surfaces to provide controllable color change. This technology can be used as a coating for dynamic camouflage, iridescent display, tunable photonic elements, or other possible applications.

It is widely known that organisms in nature can display spectacular colors. The coloration is primarily based on two mechanisms: pigmentary coloration ascribed to chemical dyes that absorb light within a narrow wavelength band, and structural coloration caused by the interference of visible light in periodic micro- and/or nanostructures, or a combination of the two. Pigmentation is more prevalent and can be dynamic, such as the melanophores found in Atlantic salmon (Salmo salar), but might suffer from photochemical degradation. On the other hand, structural coloration can have brilliant colors and tunable properties by real-time alteration of structure geometry such as the iridophores found in neon tetras (Paracheirodon innesi). Furthermore, these two mechanisms can also work together for dynamic color, such as those observed in Atlantic salmon (Salmo salar) and panther chameleons (Furcifer pardalis).

Structural colorations have been identified in a number of structures that are found in nature, including photonic crystals, diffraction gratings, and spiral coils. These structural colorations can create either iridescent behaviors, where the colors gradually change as incident or viewing angles are varied, or noniridescent behaviors, where certain colors are reflected evenly at broad viewing angles. Two prominent examples of iridescent and noniridescent photonic crystals can be found in features of green peacocks (Pavo muticus) and blue-and-yellow macaws (Ara ararauna, Psittacidae), respectively.

Going beyond photonic structure with static coloration, some structures exhibit dynamic color changes that are responsive to stimuli. These structures can be utilized for camouflage that adjusts to different environments, visual communication for aposematics and mating, and hidden signals that can be detected by polarization-sensitive organisms of conspecifics but not by predators. To achieve dynamic color change, especially dynamic iridescence, lattice spacing of periodic nanostructures can be varied to alter the interference conditions. This is also known as the “accordion” mechanism, where the lattice constant is mechanically strained by swelling or shrinking. This mechanism can be applied to one-dimensional (1D) multilayer platelets, two-dimensional (2D) rod arrays, and three-dimensional (3D) crystals. It should be noted that the 1D, 2D, and 3D here refer to the periodicity of the structures. These 1D structures can be found in the squid (Loligo pealeii), the paradise whiptail (Pentapodus paradiseus), and the blue damselfish (Chrysiptera cyanea), where ordered multilayers in iridophore cells swell to change color. The panther chameleon (Furcifer pardalis) can adjust the lattice constant of 3D guanine photonic nanocrystals by relaxing (or exciting) its skin, resulting in a strong blue (or red) shift. Using the accordion mechanism, magnetic tunable photonic structures have been demonstrated by colloidal nanocrystal clusters. In addition to lattice changes, the refractive index can also be altered to adjust the optical wavelength within the medium, thereby shifting the interference condition. The beetle (Charidotella egregia) is using this approach to modify the refractive index of each layer in a 1D Bragg mirror, switching the color from red to gold. Using the same mechanism, the beetle (Hoplia coerulea) can modify color from blue to green.

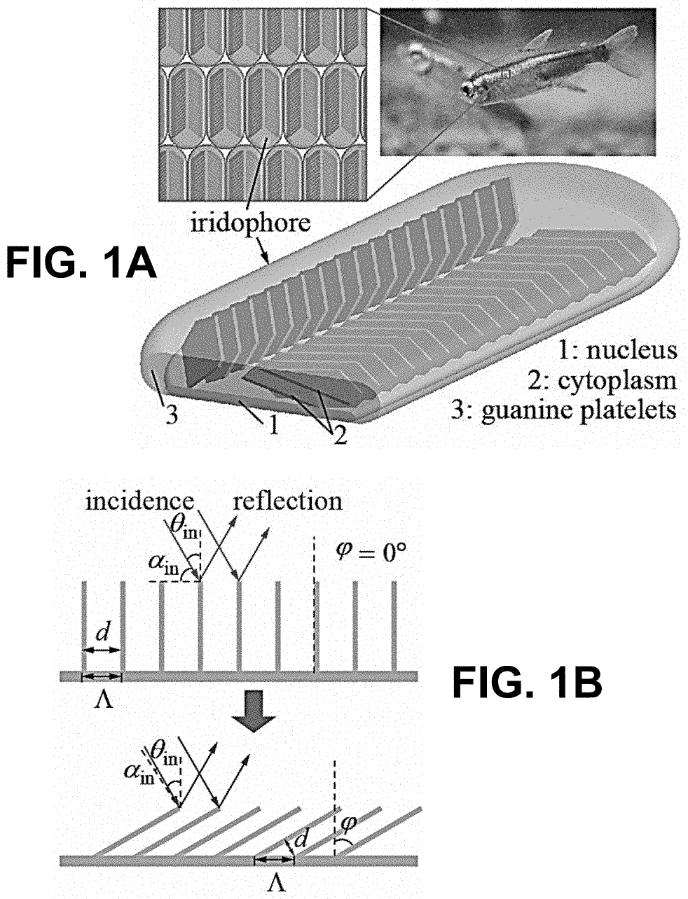

In comparison, the tropical fish neon tetra (Paracheirodon innesi) uses a different mechanism for color change. In this approach, the structure orientation of a 1D periodic Bragg mirror stack is tilted by rotation about the base without changing lattice constant. This effectively reduces the gaps between the neighboring platelets about the facet normal, similar to a “Venetian blind”. FIG. 1A shows the neon tetra and schematically illustrates it photonic structures. The lateral stripe contains iridophore arrays, with two lateral strips on neon tetra Paracheirodon innesi packed by iridophore cells. Each iridophore cell contains two stacks of ordered parallel guanine platelets, a nucleus substrate, and cytoplasm that fills the space between platelets as shown in the enlarged view. The alternating layers with high (guanine) and low (cytoplasm) refractive indices form a multilayer reflector, contributing to peak reflection for the wavelength which is twice distance between the guanine platelets. The schematic diagram of FIG. 1B illustrates the Venetian blind mechanism that can be used for dynamic iridescence. With a constant incident angle θᵢₙ and lattice constant A, the platelets can be tilted with angle φ to change the perpendicular spacing between the platelets d=Λcos(φ), thereby modifying the coloration. However, the use of artificial nanostructures or submicrostructures for tunable iridescence as specified by Venetian blind mechanism has not been explored.

In this disclosure, a strategy is introduced for dynamic iridescence by modifying the orientations of nanostructures according to the Venetian blind mechanism inspired by neon tetra. This approach is based on employing a periodic magnetic nanopillar array as a template to guide the assembly of nanoparticles (e.g., iron oxide, nickel, cobalt, iron, or other magnetic nanoparticles) in a liquid environment. Under an external magnetic field, the nanopillar array will generate a periodic local field to guide the self-assembly of iron oxide nanoparticles into periodic self-assembled columns (SACs). The local field generated also has an “anchor effect” and immobilizes the base of SACs, allowing them to be tilted about the base to induce color change. Using this method, a fabricated sample demonstrated dynamic iridescence with a short response time around 0.3 s, high intensity tunability of up to 4-fold, and large peak wavelength shift of 190 nm in the visible range. The magnetically tunable material can be readily integrated on arbitrary surfaces to induce dynamic optical appearance.

The proposed Venetian blind mechanism has several advantages over the traditional accordion approach because the orientations of the photonic structures are modified without changing the lattice spacing. This can produce broader wavelength tuning range, which would require large strain using the accordion approach. In addition, the accordion approach generally requires the structure period to be similar to or smaller than the wavelength of visible light, such as those observed in colloidal particles with 100-155 nm diameter and multilayer reflector with interbilayer distance between 66 and 250 nm. However, such fine features increase fabrication demand and cost, especially for large areas. On the other hand, the peak reflection in the Venetian blind approach is related to the normal distance d, which can be smaller than the lattice constant Λ with tilt angles. As a result, the structures with larger feature size (Λ˜2 μm in this work) can be used to achieve color change in the visible spectrum. In addition, spatially varying magnetic field profiles can be implemented using integrated microelectromagnet, which can lead toward a programmable surface. Magnetic actuation also has low energy consumption, short response time, and high repeatability compared with other methods such as pH, temperature, electrochemical activation, and mechanical force. Tunable magnetic microstructures that imitate the Venetian blind mechanism are explored using the tilting mechanism to tune the reflectance spectra and color appearance in real time.

This disclosure presents mechanisms to achieve dynamic iridescence based on the tilting of periodic photonic nanostructures. A periodic array of magnetic nanopillars (e.g., 1D or 2D array) can serve as a template to guide the assembly of iron oxide nanoparticles when magnetized in a liquid environment. The periodic local fields induced by the magnetic template anchor the assembled particle columns, allowing the structure to tilt about the base when the angle of the applied field is changed. This effect emulates a microscopic “Venetian blind” and results in dynamic optical properties through structural coloration that can be tuned in real time.

A fabricated prototype demonstrates tunable reflectance spectra with a peak wavelength shift from 528 nm to 720 nm. The magnetic actuation mechanism is reversible and has a fast response time of about 0.3 s. This structure can be implemented on an arbitrary surface as, e.g., dynamic camouflage, iridescent display, and/or tunable photonic elements, as well as in other applications such as, e.g., active fluidic devices and particle manipulation. Reference will now be made in detail to the description of the embodiments as illustrated in the drawings, wherein like reference numbers indicate like parts throughout the several views.

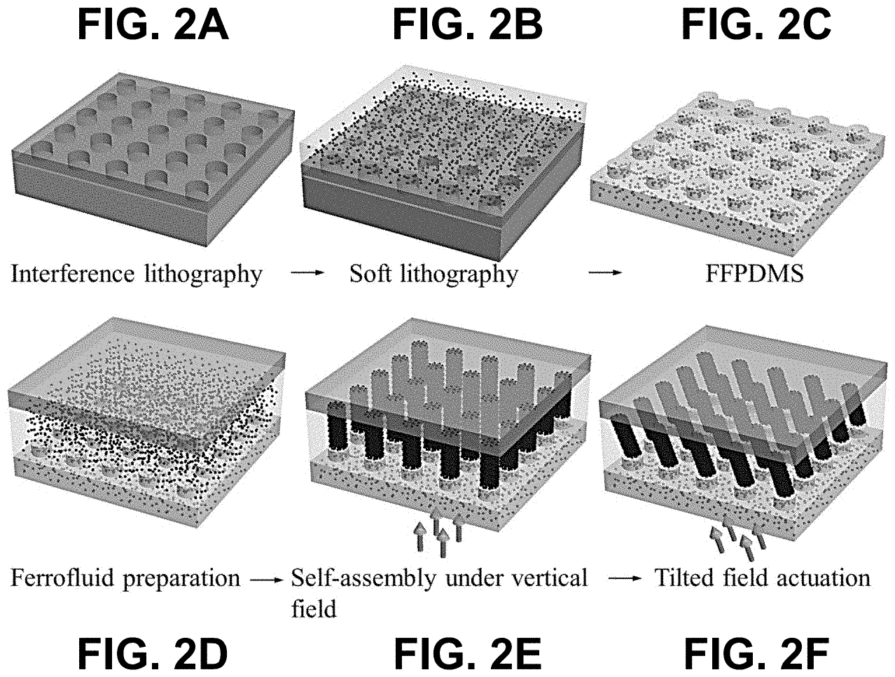

The fabrication of magnetic periodic template can be implemented using a combination of interference lithography and soft lithography as illustrated in FIGS. 2A-2C. A periodic SU-8 mold can fabricated by interference lithography, electron beam lithography, focused-ion beam lithography, atomic force probe lithography, nanoimprint lithography, etc. Negative photoresist SU-8 and anti-reflective coating (ARC) can first be deposited onto a silicon substrate by spin-coating. The photoresist can then be patterned using, e.g., Lloyd's mirror interference lithography (IL) with a 325 nm wavelength laser to generate a 2D periodic array of circular holes as shown in FIG. 2A. The pattern serves as a master for soft lithography molding the magnetic polymer material as shown in FIG. 2B. For example, the magnetic polymer material can comprise iron oxide nanoparticles (magnetite or Fe₃O₄, with a diameter of 7-10 nm) and a copolymer of aminopropylmethylsiloxane (APMS) and dimethylsiloxane (DMS). The nanoparticles are bound with amine groups on the copolymer chains to establish a uniform ferrofluid complex, also called ferrofluid polydimethylsiloxane (FFPDMS). Details of material properties of FFPDMS are provided in Section A—Synthesis and Characterization of FFPDMS. After synthesis, the FFPDMS precursor fills into SU-8 master and is cured by formaldehyde vapor in vacuum environment. After separation, the cured FFPDMS yields in a 2D periodic array of magnetic nanopillars as shown in FIG. 2C. More fabrication details are shown in Section B—Interference lithography and soft lithography.

After the FFPDMS nanopillars array is prepared, it can serve as a template to direct the assembly of magnetic nanoparticles. This process is illustrated in FIGS. 2D-2F, where a polydimethylsiloxane (PDMS) microfluidic channel (e.g., with 20 μm depth) can be prepared using standard microlithography methods to encapsulate the surface. A water-based ferrofluid (e.g., composed of 0.125% (by volume) iron oxide nanoparticles with 10 nm diameter) can be introduced into the channel as shown in FIG. 2D. The details of ferrofluid are shown in Section C—Characterization of Ferrofluid. Under an out-of-plane external magnetic field, the iron oxide nanoparticles in the ferrofluid align to the field direction and assemble into SACs on top of the FFPDMS pillars as shown in FIG. 2E. This increases the aspect ratio of the periodic assembled structure. At the same time, the SACs are anchored to the top of the nanopillar template, allowing the SAC to be rotated about its base. The template-directed SACs can be actuated and tilted to different angles by varying the direction of the magnetic field as shown in FIG. 2F.

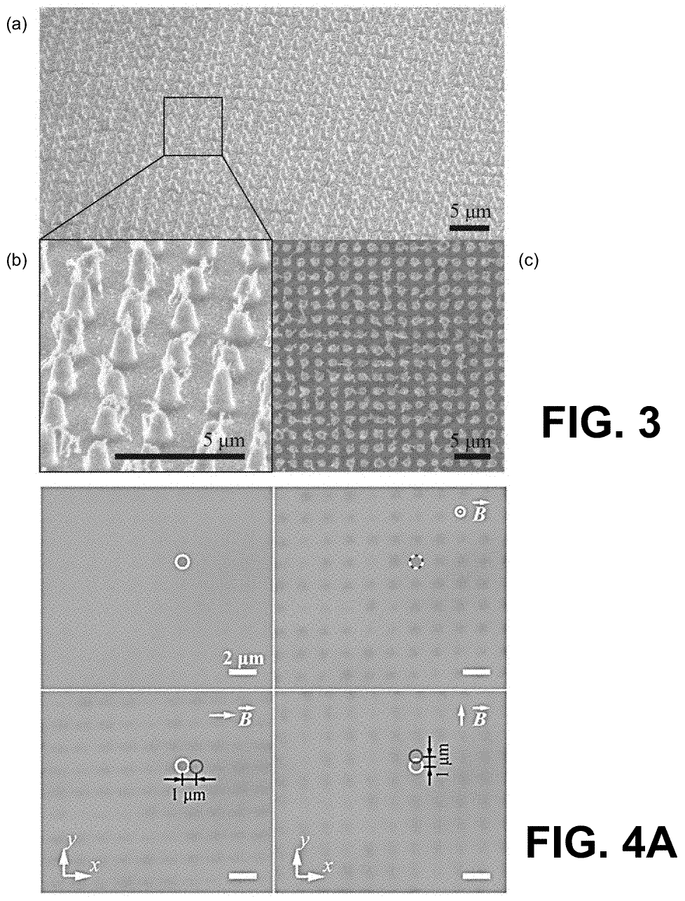

The fabricated FFPDMS nanopillar array template is illustrated in the scanning electron microscope (SEM) images of FIG. 3. The side-view SEM images over a large area and high magnifications are shown in parts a (top) and b (bottom left) of FIG. 3, respectively. A top-view SEM image of the pillar is shown in part c (bottom right) of FIG. 3. The FFPDMS nanopillars has a square lattice with period of 2 μm. Each pillar is roughly 1 μm in diameter and has a height-to-diameter aspect ratio of around 1. Note that there is some surface roughness on the pillars, which may be attributed to polymer residue from the replication process. There is also a uniform residual layer of FFPDMS under the pillar structures with a thickness of approximately 20 μm.

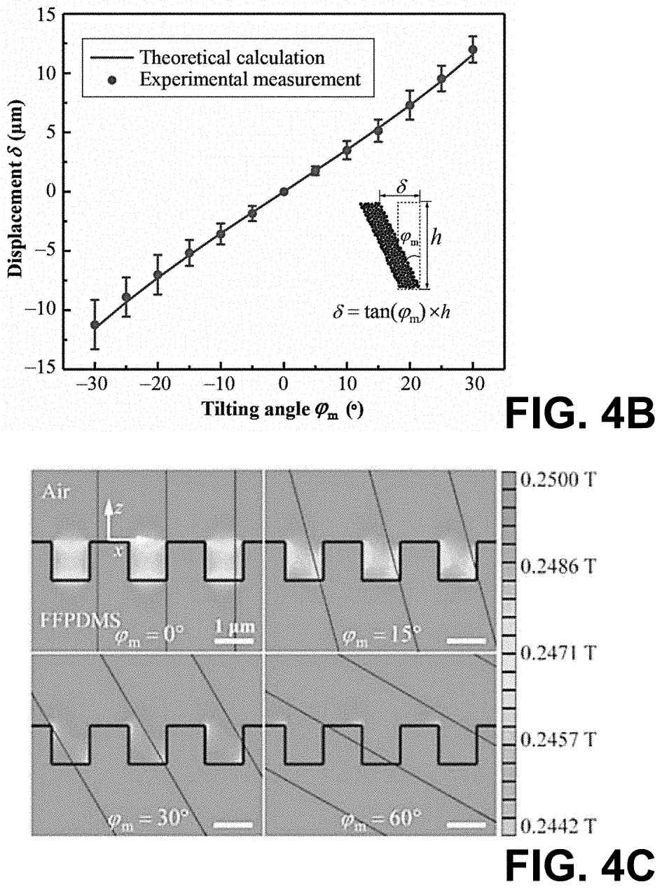

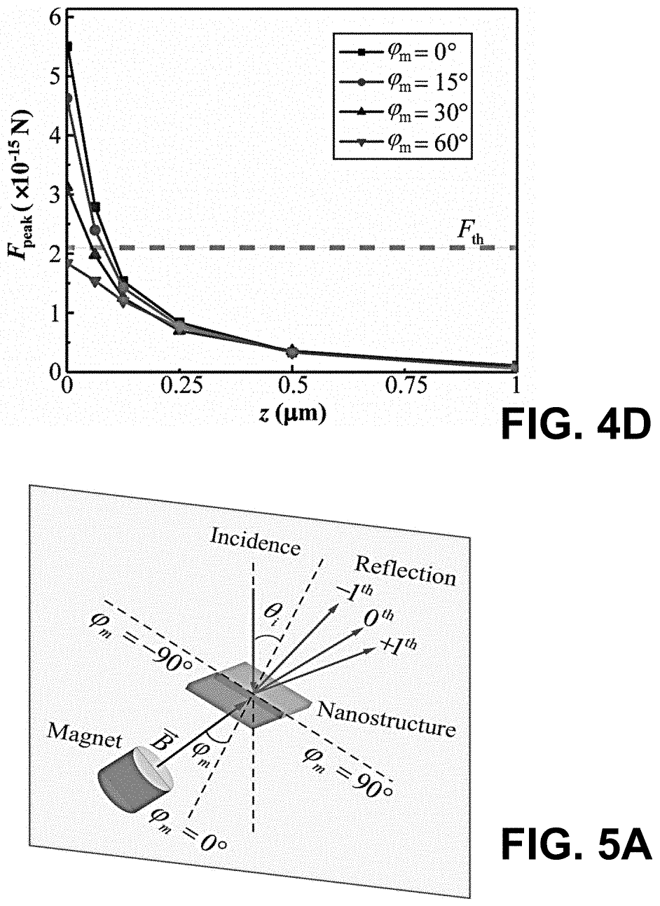

Characterization of Magnetic Tilt Actuation. The tilting behavior of the SACs on top of the FFPDMS nanopillar template was examined using top-view optical microscopy. Images of the magnetic actuation corresponding to different magnetization conditions were obtained and analyzed. FIG. 4A shows microscopic images of a ferrofluid with no field (top-left image), vertical field (top-right image), tilted field toward the positive x direction (bottom-left image), and tilted field toward the positive y direction (bottom-right image). The white circle indicates the original position of a FFPDMS pillar and the dark circle describes the deflected position of the SACs. The scale bars in images are 2 μm. Initially, in the absence of an external magnetic field, the profile of the FFPDMS template is blurry because the nanoparticles in the ferrofluid are randomly distributed and scatter light. The top of one pillar is denoted by the white circle in the top-left image of FIG. 4A. When an out-of-plane external magnetic field is applied, the SACs form on top of the FFPDMS pillars and periodic patterns can be observed. The top of the SAC is denoted by the dark circle, which overlaps with the white circle, as shown in the top-right image of FIG. 4A. When the external field is applied with angle φₘ=3° toward the positive x direction, as shown in the bottom-left image of FIG. 4A, the tops of the SACs shift about 1 μm toward the same direction. The displacement can be readily observed by the horizontal offset between the positions of the dark and white circles, demonstrating that the SACs are tilted toward positive x direction. Similarly, when the external field is aligned at 3° toward the positive y direction, the tops of the SACs move about 1 μm toward that direction, as shown in the bottom-right image of FIG. 4A. More complex actuation maneuvers can include rotation of the SACs in clockwise and counterclockwise directions. Once the field is removed, the SACs disperse back into water within 0.3 s. The transient response of the assembly is described in more details in Section D—Response Time of Self-Assembled Columns.

Further characterization of the relationship between the magnetic field angle φₘ and the tilt actuation of SACs is summarized in FIG. 4B. The curve of the tilted displacement 6 of SACs and the tilt angle φₘ of the external field is shown, which was extracted by analyzing the microscopic images. It indicates that the SACs tend to align along the external field direction. Error bars represent the standard deviation in displacement. Assuming the top of the SACs is confined by the microfluidic channel while the bottom is anchored on the FFPDMS pillars, as shown in the inset schematic of FIG. 4B, then the vertical height of SACs is constant at h=20 μm. Thus, the displacement of the top of SACs is given by 6=tan(φₘ)·h. The experimental data and theoretical model agree well, demonstrating that the SACs can be tilted along the external field direction.

This also suggests the tilt actuation is a dynamic process that involves particle reorganization, which not only alters the orientation of the SACs but also elongates their length when compared with non-tilted columns. The error bar for the data is calculated as the standard deviation of six independent measurements. At larger field angles, φₘ>30°, the formation of the SACs has lower yield and further degrade. This may be attributed to two possible failure mechanisms: (1) the weakening of the anchor effect from the magnetic template, and (2) the degradation of assembly conditions, both of which will be discussed in more detail. As a result, the SACs cannot be systematically detected and are no longer periodic. As a result, the dynamic range of the actuation angle tilt is limited to ±30° in this work. Larger tilt angle may be achieved for other implementations (e.g., ±35°, ±40°, ±45°, etc.).

To investigate the underlying mechanism of tilted SACs, field-induced aggregation of magnetic nanoparticles in a fluid medium should be considered. When a thin layer of ferrofluid is confined by two parallel planes and subjected to out-of-plane magnetic field, the nanoparticles aggregate and form aligned chains along the field direction. The vertical chains combine and form columns, resulting in the larger SACs. The formation of the SACs is a quasi-equilibrium process that involves the balance of magnetic energy, surface energy, and entropy. From established theoretical models, it can be observed that the particles require lower magnetic energy to assemble in channels with a smaller confinement height. Therefore, when a periodic template is used instead of a flat plane, the particles tend to form columns first on the pillars rather than in the valleys. This may be attributed to the smaller confinement gaps h on the pillars, which results in less surface area and requires lower energy when the SACs form on the pillars as opposed to valleys. With an appropriate external field, the columns on pillars will repel each other to prevent other columns from existing in the valley, resulting in another configuration: a periodic rectangular pattern. In this case, the periodic template serves as a topography guide, and can be made by nonmagnetic material. However, nonmagnetic templates do not contribute to the anchoring of the SACs, which readily slips off when the magnetic field is applied at an angle.

To better interpret the anchor effect of the magnetic template and understand the failure mechanisms at large φₘ, simulations of the magnetic field profiles have been performed. FIG. 4C depicts simulations of the local magnetic field on the FFPDMS pattern. The topography of FFPDMS pillars was modeled as a periodic rectangular grating with 2 μm period, 1 μm width, and 1 μm height. The external magnetic field was set as 0.25 T. The shading denotes magnetic flux density, while the black lines illustrate the magnetic field direction. The scale bars in images are 1 μm.

When the external field is aligned vertically with tilt angle φₘ=0°, the map shows that the FFPDMS pillars generate a periodic local field distribution. The magnetic flux density on the pillar tops is about 0.005 T higher than in the surrounding valleys, which induces a large field gradient of 4×10⁴ T/m. This creates a horizontal magnetic force attracting and trapping the base of the SAC, leading to the anchor effect. More details on the calculation of the magnetic force are described in Section E—Magnetization and Magnetic Force of FFPDMS.

An estimate of the horizontal magnetic force can be calculated using the force equation F=∇(m·B). The peak horizontal magnetic trapping force Fₚₑₐₖ on a single nanoparticle is plotted as a function of the distance z away from the template. FIG. 4D depicts the comparison of the peak magnetic forces Fₚₑₐₖ at different tilt angles and the effective force of thermal fluctuation Fₜₕ. When φₘ 30° and z<0.125 μm, the anchor effect can be maintained because Fₚₑₐₖ>Fₜₕ. The magnitude of the force is consistent with literature values observed in nanoparticle trapping. For the particle to be trapped, the force has to overcome the effective force of thermal fluctuation Fₜₕ, also shown in the figure. As mentioned, it can be observed that Fₚₑₐₖ>Fₜₕ when z<0.125 μm and φₘ 30°, which indicates that trapping only occurs near the bottom of the SACs. Such an effect can overcome the random movements of SACs on a nonmagnetic template due to thermal fluctuation (see, e.g., Section E—Magnetization and Magnetic Force of FFPDMS and Section F—Field-Induced Nanoparticle Assembly on Non-Magnetic Templates). However, at large z above the pillars, the field profile becomes more uniform, thus decreasing the attraction forces and allowing the upper parts of the SACs to move freely.

When the external field is tilted at an angle, the periodic local field distribution will shift toward the field direction, as illustrated by the black solid parallel lines in FIG. 4C. For φₘ 30°, the magnetic force induced by the periodic template is still sufficient to trap particles to the base. As a result, the SACs will be aligned along the tilted external field direction while the base remains trapped on the templated FFPDMS pillars. If the tilt angle is too large, as shown in the case of φₘ=60°, the magnetic trapping force Fₚₑₐₖ<Fₜₕ and the template will no longer anchor the SACs, leading to the first failure mechanism. This can be observed in the low anchoring yield for large φₘ, as shown in Section G—Dynamic Tilt Range of SACs. This model describes the mechanism of the magnetic anchor effect, which allows the rotation of the SACs about its base.

In addition to the weakening of the anchor effect, large φₘ can also lead to the degradation of the SAC assembly conditions, the second failure mechanism. This may be attributed to the non-normal confinement, which elongates the tilted SACs and increases their surface area. For such assemblies to be stable, additional magnetic energy would have to be introduced, which is not the case in the disclosed system because the field magnitude is kept constant. This then leads to an imbalance of magnetic and surface energies, causing the assembly to degrade at large φₘ. In this regime, the SACs tend to form longer, noncylindrical chains with large variations in diameter. The tilted permanent magnet can also induce a weak horizontal force through the in-plane field gradient, causing the SACs to continuously slide toward one direction. In addition, non-normal magnetization can introduce a horizontal internal shear force on the SACs to further degrade the assembly. However, for small angles, the shear is small when compared to the out-of-plane component that drives the particle assembly. The degradation of the SACs at large φₘ is discussed in more detail in Section G—Dynamic Tilt Range of SACs.

On the basis of the magnetic models that show poor trapping effect and the experimental observation that the particle assemblies are unstable and nonuniform for φₘ>30°, the dynamic angle range of the tilt actuation is estimated to be −30° φₘ<30° for this work. Even though some SACs can still form and be anchored at larger external field angles, the yield can be low. In this regime, the tilted SACs are no longer periodic, which is a condition for structural coloration.

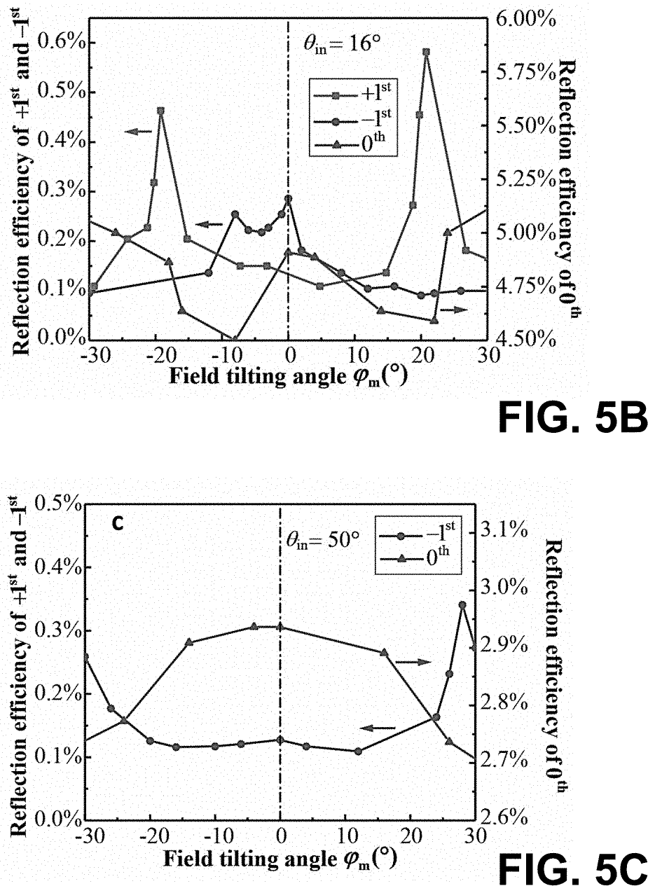

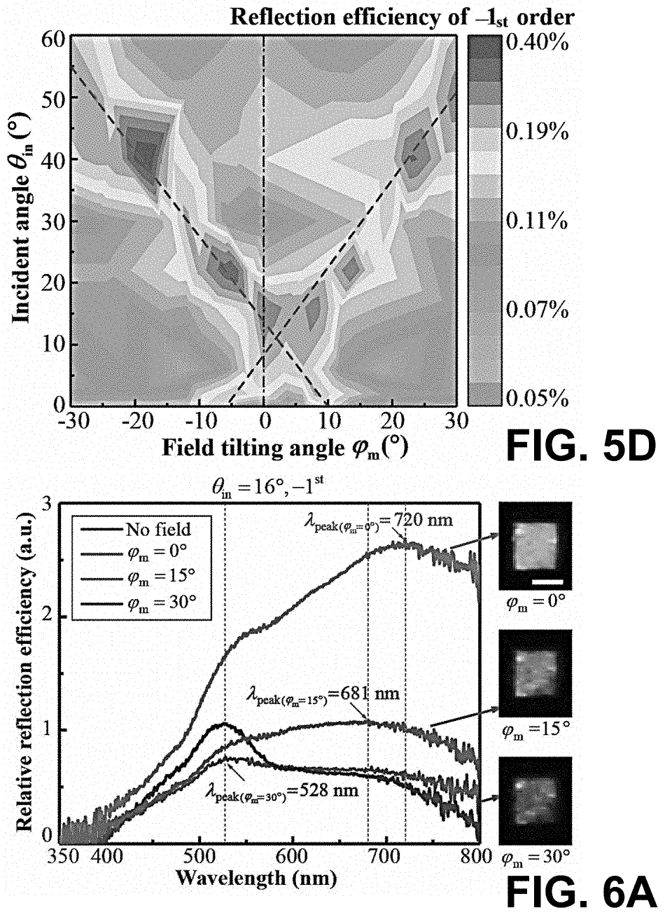

Optical Characterization. The fabricated prototype enables real-time control of the SACs tilt angle, which can trigger changes in optical properties. To demonstrate dynamic iridescence, the reflection efficiency of the fabricated device was characterized using a 633 nm laser. In this configuration, the light was incident on the structure at an angle θᵢₙ and induces different discrete diffraction orders based on Bragg's law. The schematic of FIG. 5A shows that there is reflection diffraction with various orders given an incident light beam with angle θᵢₙ. The efficiency of the +1st, −1st, and 0th orders are measured under external magnetic field with tilt angle φₘ. A permanent magnet was installed on a rotational stage with the sample located at its center, hence the magnet can tilt with angle φₘ at a constant distance. The efficiencies of +1st, −1st, and 0th orders were measured with φₘ=16° and TE polarization, as shown in the efficiency curves (θᵢₙ=16°) of FIG. 5B. When φₘ increases from 0° to 20°, the efficiency of the +1st order increases from 0.13% to a peak of 0.58%. This is conducive to a relative efficiency increase of roughly 4-fold. In contrast, the efficiency of the −1st order decreases from a peak of 0.29% to 0.12% when φₘ increases from 0° to 20°, respectively. This indicates that +1st and −1st orders have opposite peak wavelength shifts and coloration effects when illuminated with white light source. On the other hand, the efficiency curve of the wavelength independent 0th order does not vary between φₘ=0° and φₘ=30°. When the incident angle θᵢₙ increases above 43°, the +1st order becomes evanescent according to Bragg's law, as shown in Section H—Optical Characterization of Dynamic Iridescent Sample. For example, when the incident angle θᵢₙ is 50°, the efficiency of the −1st order has a sharp peak of 0.34% at φₘ=28° with an efficiency increase of about 2-fold, while there is no+1st order, as shown in the efficiency curves (θᵢₙ=50°) of FIG. 5C.

Considering the angular effects of the incident light and magnetic alignment, the efficiencies of the −1st order are plotted as a contour versus θᵢₙ and φₘ. FIG. 5D shows an example of a 2D efficiency contour of the −1st order versus different incident angles and tilt angles. These results demonstrate that the reflection efficiency at 633 nm can be tuned from close to zero to 0.4%. This in turn generates different shades of red with changing magnetic alignment angle, demonstrating dynamic coloration and viewing angle dependence. It is interesting to notice that the efficiency of the −1st order is roughly symmetric with respect to the line θᵢₙ=0°. This can also be observed in the efficiency contour, where the peak efficiencies form symmetric lines and cross at about φₘ=5° (dashed lines of FIG. 5D). This may be attributed to the variation of assembly quality with magnetization angle. When φₘ is nonzero, the magnetic field is not perpendicular to the physical confinement, inducing lower nanoparticles density packing. This effect is the same for tilt in both positive and negative direction, contributing to the efficiency symmetry. The efficiencies of the +1st and 0th orders are also symmetric and can be found in Section H—Optical Characterization of Dynamic Iridescent Sample.

The absolute reflection efficiencies of the structure are relatively low, which may be attributed to the scattering and absorption of the residual FFPDMS layer. The reflection efficiency of silicon substrate is around 30%, and the absorption of FFPDMS residual layer is about 39%, which results in expected total reflection of 11.2%. The measured total efficiency for all orders is around 9%, which can be attributed to additional losses in the ferrofluid and PDMS microfluidic channel. The absolute efficiency can be improved by using a more reflective substrate, reducing the residual layer thickness and coating a thin reflective layer such as gold onto the FFPDMS template.

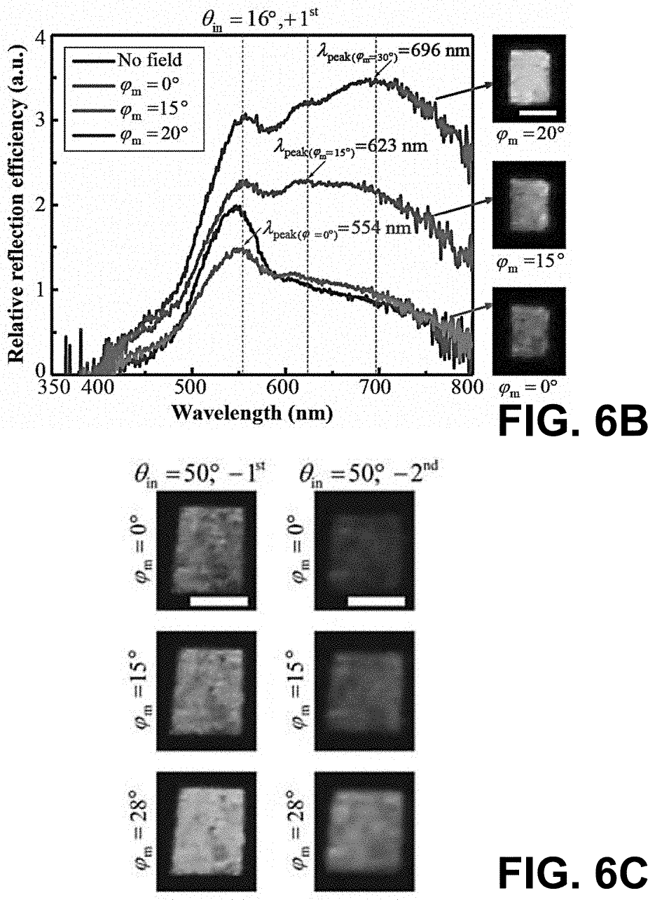

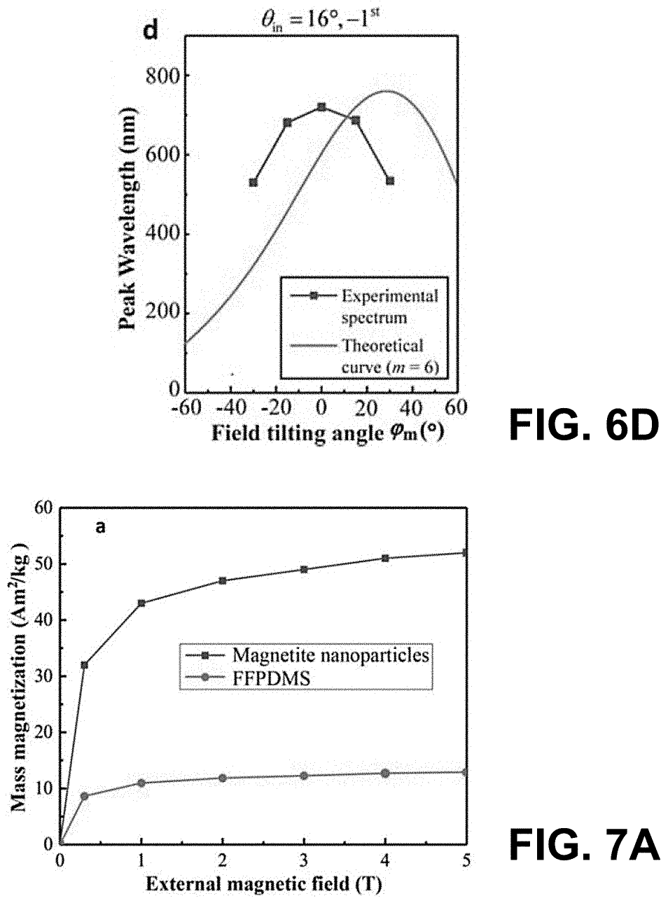

The structural coloration of the fabricated sample can be demonstrated by characterizing the reflectance spectra from 350 to 800 nm using a UV-vis-NIR spectrophotometer (e.g., Agilent Cary 5000). The details of the optical setup are shown in Section H—Optical Characterization of Dynamic Iridescent Sample. The measured spectra for the −1st and +1st orders at θᵢₙ=16° with different magnetic alignment angles φₘ=0 −30° are shown in FIGS. 6A and 6B. The visual appearance of the fabricated sample with a white light source at θᵢₙ=16° was recorded using a camera with standard RGB color space, as shown in the inset diagrams. FIG. 6A shows the spectra of the −1st order reflection diffraction at θᵢₙ=16° indicating a strong blue-shift, verified by the camera images on the right side. FIG. 6B shows the spectra of the +1st order reflection diffraction at θᵢₙ=16° indicating a strong red-shift and was demonstrated by the camera images on the right side. The scale bars in the camera images are 1 mm.

The real-time color tuning is possible. As the field is tilted from φₘ=0° to φₘ=30°, the color appearance of the −1st order can be varied from bright yellow to dark green, and the peak wavelength of the spectrum shifts from 720 to 528 nm, generating a blue-shift of 192 nm. This gives rise to a relative wavelength tunability Δλ/λ₀=(λₚₑₐₖ−λ₀)/λ₀=−26.7%, where λ₀ is the initial peak wavelength at φₘ=0° and λₚₑₐₖ is the peak wavelength at φₘ=30°. The negative sign represents a blue-shift for the −1st order. On the contrary, the color appearance of the +1st order changes from dark green to yellow with a red-shift when the field is tilted from 0° to 20°. The measured spectra indicate a red-shift of 142 nm, from 554 to 696 nm, with a tunability Δλ/λ₀=+25.6%. The comparisons of coloration and spectrum shifts for the +1st and −1st orders confirm the prediction of opposite behaviors in efficiency measurement in FIG. 5B. In addition, the peak wavelength shifts of −1st and +1st orders at negative tilt angles are similar to the shifts at positive tilt angles, as shown in Section H—Optical Characterization of Dynamic Iridescent Sample. The demonstrated peak wavelength shift is larger than those observed in organisms based on changes in index and strain, such as the beetle (shift of 80 nm from 450 to 530 nm) and paradise whiptail (shift of 185 nm from 465 to 650 nm), respectively. Most notably, the demonstrated peak wavelength shift is larger than those observed in the neon tetra (shift of 90 nm from 400 to 490 nm), which is also based on the Venetian blind mechanism.

Beyond the shift of the peak wavelength, however, the measured spectra highlight a number of limitations for other optical properties. First, the overall reflection efficiency is low, which can be attributed to absorption and scattering of the FFPDMS as described previously. Second, it can be observed that the measured bandwidth in the reflectance spectra is relatively broad when compared with biological counterparts. It is therefore important to note that the perceived color does not correlative solely to the peak wavelength. For example, the peak wavelength of the +1st order at φₘ=15° is 623 nm, but the sample does not appear to be red. This may be attributed to another strong peak near 550 nm, which originates from the diffraction of the FFPDMS template, leading the perceived color to be yellowish green. Note at φₘ=20° the peak wavelength of the +1st order goes beyond the visible range to 720 nm, while the color of the sample appears yellow due to the secondary peak at green. The broad reflectance bandwidth can be due to the relatively short SACs lengths, resulting in fewer layers in the multilayer reflector. This is in contrast to the coherent reflection of stacked 1D platelets observed in neon tetra, which results in higher efficiency and narrower reflectance bandwidth. In addition, the SACs might also result in lower particle packing density during tilt actuation, which would induce lower index contrast with the liquid and further broaden the reflectance bandwidth. Increasing the height of the SACs can result in more structure periods along the light path for a more effective multilayer reflector and will be explored as potential solution to sharpen the reflectance bandwidth and increase reflection efficiency.

The color appearance is also dependent on incident and viewing angles, characteristic of iridescence. When the light incident angle is increased to θᵢₙ=50°, there is a red-shift from green to yellow as the field tilts from φₘ=0-30°. FIG. 6C shows the dynamic iridescence at θᵢₙ=50° for different orders. The left column shows a red-shift from green to yellow, and the right column indicates a red-shift from indigo to orange. The scale bars are 1 mm. Note this is also consistent with the efficiency measurement in FIG. 5C. When the viewing angle is changed by about 2° and then kept fixed during the tilt actuation of SACs, the dynamic iridescence produces a broader red-shift from indigo to orange. At even larger viewing angle of about 8°, it is possible to observe dynamic iridescence of the −2nd order, as shown in FIG. 6C. The color appearance demonstrates a red-shift from green to orange, which is measured at a lower efficiency of about 0.1%.

To better understand the color shift mechanism, the peak wavelength λₚₑₐₖ can be plotted as a function of magnetization angle φₘ. FIG. 6D shows the peak wavelength of the measured spectra for the −1st order and the theoretical curve using 1D multilayer reflector model. On the basis of the Bragg reflector model, the peak wavelength can be calculated by constructive interference from alternating layers with high and low refractive indices corresponding to assembled nanoparticles and ambient water, respectively. The peak reflection occurs when the total normal distance between neighboring layers d is equal to an integer multiple m of a quarter of the light wavelength. When the angle φₘ varies, d changes to induce a shift in peak wavelength. The detailed derivation can be seen in Section H—Optical Characterization of Dynamic Iridescent Sample. Because the structure period of approximately 2 μm is used to affect visible light in this work, a higher order with m=6 is chosen for modeling. It can be deduced from FIG. 6D that the peak wavelength of the −1st order from spectra matches with the theoretical curve. Note the model predicts an asymmetric wavelength shift with respect to φₘ, which was not replicated in the data due to degradation of particle assembly density at large φₘ.

It should be recognized that the 1D multilayer Bragg reflector model is an approximation of the fabricated structures because both the magnetic template array and the SACs comprise 2D periodic structures. A more comprehensive optical model of all different diffraction orders, as well as the bandwidth of the reflectance spectra, can be provided. The proposed approach can also be implemented using 1D magnetic grating templates, which would result in nanoparticle assembly that more resemble platelets observed in neon tetra. The optical behavior of such structures can contain fewer diffraction orders and be better described by the Bragg model. However, the anchor effect in these structures would behave differently in the direction parallel to the template. Analysis of the dynamic iridescence behavior of the tunable 2D SACs under polarized light can lead to tunable birefringence and other polarization-dependent effect.

The proposed dynamic iridescence approach is enabled using a water-based ferrofluid within a microfluidic channel, and several considerations including sample reusability and water evaporation should be taken in account. The FFPDMS surface can be conveniently cleaned with a deionized water rinse due to the surface hydrophobicity to remove any nanoparticle residual, and therefore the FFPDMS template can be reused before becoming contaminated. Any water leakage may lead to evaporation through the inlets and edges of the microfluidic channel, which would limit the long-term durability of the device. The ability to achieve dry magnetic nanostructure with tunable tilt in ambient environment would be a more attractive alternative. However, high aspect ratio FFPDMS nanostructures offers a challenge to fabricate such a device.

An engineered nanostructured material with dynamic coloration and iridescence that can be magnetically tuned has been reported. This is based on a “Venetian blind” mechanism, where the structure orientation is altered in real time to control the optical reflectance spectra. In this approach, the lithographically patterned FFPDMS pillar arrays function as an anchor for field-induced self-assembly of magnetic nanoparticles. This “anchor effect” enables the assembled columns to be tilted about the base, which changes the light interference condition. The fabricated structures demonstrated reversible color shifts from green to yellow with peak wavelength shift up to 192 nm. This approach offers potential applications for tunable magnetic structures as well as dynamic photonic devices by tilting the orientations of periodic structures. The proposed magnetic actuation can also be implemented using integrated electromagnets, which can lead to programmable iridescent display under ambient light. This active material system can also find applications in dynamic camouflage coating, optical logical devices, microfluidics, and particle manipulation.

Interference Lithography and Soft Lithography. An example of the fabrication process is now presented. First, anti-reflective coating (ARC) was spin-coated onto a silicon wafer and baked at 90° C. for 1 min on a hot plate. Then SU-8 2002 was spin-coated onto the ARC and soft baked at 95° C. for 1 min on a hot plate. After exposure using Lloyd's mirror IL, the SU-8 sample was postexposure baked at 90° C. for 1 min on a hot plate, developed in PGMEA for 1 min, and rinsed with deionized water. FFPDMS precursor with 25 wt % of iron oxide nanoparticles was applied onto the SU-8 template in a desiccator with 15 μL of formaldehyde, then the desiccator was pumped to −29 inHg vacuum for 6 h. After curing, the FFPDMS template was mechanically separated from SU-8 master. Ferrofluid (EMG 707, FerroTec) was confined on the FFPDMS using PDMS microfluidic channels fabricated by standard microlithography. For a magnetic field of 0.25 T, channel depth of 20 μm, and particle volume fraction 0.125%, the SACs formed a rectangular periodic pattern on FFPDMS template with average spacing of 2 μm. More details of materials and fabrication processes are shown in Sections A-C.

Simulations and Software. The magnetic field distribution contours in FIG. 4C were simulated by the software FEMM. The magnetic properties of FFPDMS are described in more detail in Section A. The displacement of SAC tops (e.g., the experimental curve of FIG. 4B) was calculated by analyzing microscopy images using ImageJ. Magnetic forces were calculated using FEMM and Matlab.

Dynamic Iridescence. The structure and magnet are installed on user-customized rotation stage. The microscopy images and videos were taken by a Leitz Wetzlar microscope with 1000× magnification. A HeNe laser with A=633 nm was used as a light source to measure the efficiency of the FFPDMS and SACs. The efficiency data was collected using a silicon detector (e.g., 918D-UV-OD3R, Newport). The spectrometry measurement was performed using UV-vis-NIR spectrophotometer (e.g., Cary 5000, Agilent). An optical system was used to achieve different incident and viewing angles, as shown in the schematic in Section H. The camera images were taken by a Canon EOS 600D with standard RGB color space.

### Section A—Synthesis and Characterization of FFPDMS

Synthesis of FFPDMS. To synthesize the FFPDMS material, iron oxide nanoparticles (7-10 nm) were precipitated from ferric chloride and ferrous chloride salts with 2:1 molar concentration in ammonium hydroxide solution. After precipitation, the nanoparticle aqueous solution was mixed with a copolymer of aminopropylmethylsiloxane (APMS) and dimethyllsiloxane (DMS) with 6-7 mol % APMS, and then stirred vigorously for 24 hours (pH 6.8-10). The amine groups on siloxane copolymer will adsorb onto the surface of positively-charged iron oxide nanoparticles to yield a siloxane-magnetite complex, which results in a black sediment in the solution. The sediment was then rinsed in methanol, water, and methanol again (5 times for each rinse step) with sedimentation facilitated by a permanent magnet. The complex can be diluted by suspending it and APMS-co-DMS copolymer in chloroform, ultra-sonicating for 30 seconds, and removing the chloroform solvent.

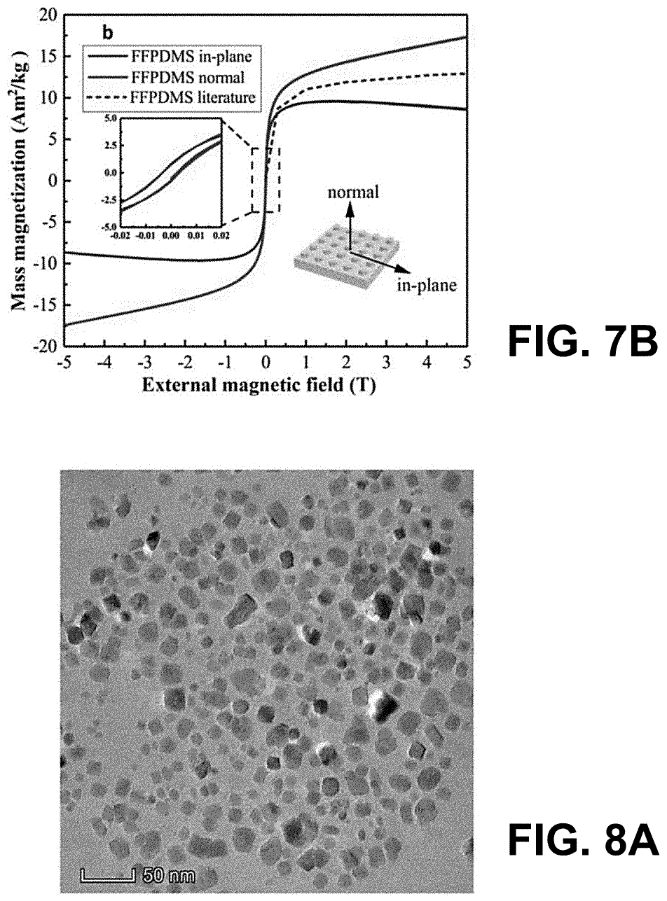

Characterization of FFPDMS. The uniformity and sizes (7-10 nm) of iron oxide nanoparticles in FFPDMS have been verified by SEM and TEM measurement previously. The magnetic properties of FFPDMS with different concentrations have also been measured using superconducting quantum interference device (SQUID) magnetometry and no significant hysteresis was observed, indicating it is superparamagnetic. Since magnetization increases linearly with nanoparticle concentration in this material, a linear interpolation indicates that the magnetization of 25 wt % magnetite nanoparticles at 300 mT is 8.68 Am²/kg and the saturation magnetization at 5 T is 12.98 Am²/kg. The mass magnetization curve of magnetite nanoparticles and FFPDMS (25 wt % iron oxide nanoparticles) was extracted from previous work and plotted in FIG. 7A and verified by experimental measurement of mass magnetization for FFPDMS, shown in FIG. 7B. Also, this magnetization curve will be utilized as the input material properties in the magnetic finite element modeling of FFPDMS template, whose result is shown in FIG. 4C. Note that the iron oxide nanoparticles in FFPDMS have diameter of about 10 nm and are superparamagnetic, which is also verified by the small coercivity in the magnetic measurement. The coercivity of FFPDMS was estimated to be 31 Oe, namely a field of 0.0031 T returns the magnetization to zero, as shown in the insert of FIG. 7B.

### Section B—Interference Lithography and Soft Lithography

The patterning of the magnetic template is achieved using laser interference lithography (IL) and soft lithography. First, an ARC (e.g., i-CON-7, Brewer Science) film with 91 nm thickness is spun onto silicon wafer and baked at 185° C. for 1 minute on a hotplate to reduce back reflection. A negative photoresist SU-8 (e.g., 2002 and 2000 thinner, Microchem) is then spin coated with 1 μm thickness and soft baked at 95° C. for 1 minute on a hotplate. A sample with about 8 mm by 8 mm size was cleaved for exposure. After two separated orthogonal laser (λ=325 nm) exposures using Lloyd's mirror IL (incident angle=4.66°, each exposure dose=4.5 mJ/cm²), a square hole array with 2 μm period was patterned in the SU-8 film. The film was post-exposure baked at 90° C. for 3 minutes on a hotplate, developed in propylene glycol monomethyl ether acetate (e.g., PGMEA, Sigma Aldrich) for 1 minute, and rinsed with IPA (e.g., 2-propanol, J. T Baker) for several seconds.

Using the SU-8 mold, 4 μL FFPDMS precursor with 25 wt % of iron oxide nanoparticles was applied by pipette, and kept in −29 inHg vacuum for 5 minutes to reduce air bubbles. Most part of residual FFPDMS outside the mold was removed gently by glass stick, then the sample was spun with 2000 rpm speed for 2 min to flatten the surface. Then the sample and a vial of 15 μL formaldehyde (e.g., 37 wt % in water, Fisher Chemical) were put separately into the desiccator and kept in −29 inHg vacuum for 6 hours. The FFPMDS would be crosslinked by the vapor deposition of formaldehyde.

After the FFPDMS is cured, the sample can be treated by oxygen plasma for 2 minutes. To transfer the surface, PDMS (e.g., Sylgard 184, Dow Corning, mixing ratio=10:1) can be applied on the surface of solid FFPDMS and kept in vacuum (e.g., −29 inHg for 5 minutes) to remove bubbles. Then the whole sample can be spun, e.g., with 500 rpm speed for 2 minutes. Afterward, a piece of silicon wafer can be treated by oxygen plasma (e.g., for 2 minutes) and attached faced-down on the PDMS sample to form a sandwich-like integration. The integration can be kept in vacuum (e.g., −29 inHg for 5 minutes) to remove bubbles and heated on hotplate (e.g., with 100° C. for one hour) to cure the PDMS. Finally, the FFPDMS template can be mechanically separated from the SU-8 mold, e.g., by a blade. As a result, the final sample is the FFPDMS template bonded on silicon substrate by PDMS.

### Section C—Characterization of Ferrofluid

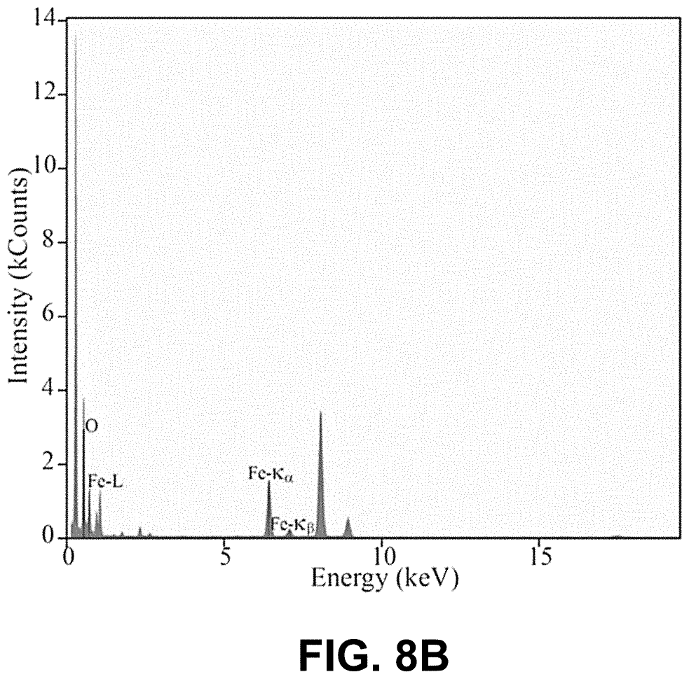

In this disclosure, a 2 vol % water-based ferrofluid (e.g., EMG 707, FerroTec) is diluted by deionized water with ratio of 1:16, therefore the nanoparticle concentration is 0.125 vol %. The transmission electron microscope (TEM) image and corresponding element analysis have been done for the iron oxide nanoparticles in ferrofluid using Talos F200X. FIGS. 8A and 8B illustrate the characterization of the iron oxide nanoparticles in ferrofluid. The diameter of thirty individual particles were extracted and measured from the TEM image of iron oxide nanoparticles of FIG. 8A, yielding an average diameter of 11.5 nm with standard deviation of 3.3 nm, which matches with the data specification from the company (nominal diameter 10 nm). In addition, the element analysis verified that the observed particles are iron oxide. FIG. 8B is the element analysis of the TEM image of FIG. 8A and verifies that the observed particles are iron oxide.

### Section D—Response Time of Self-Assembled Columns

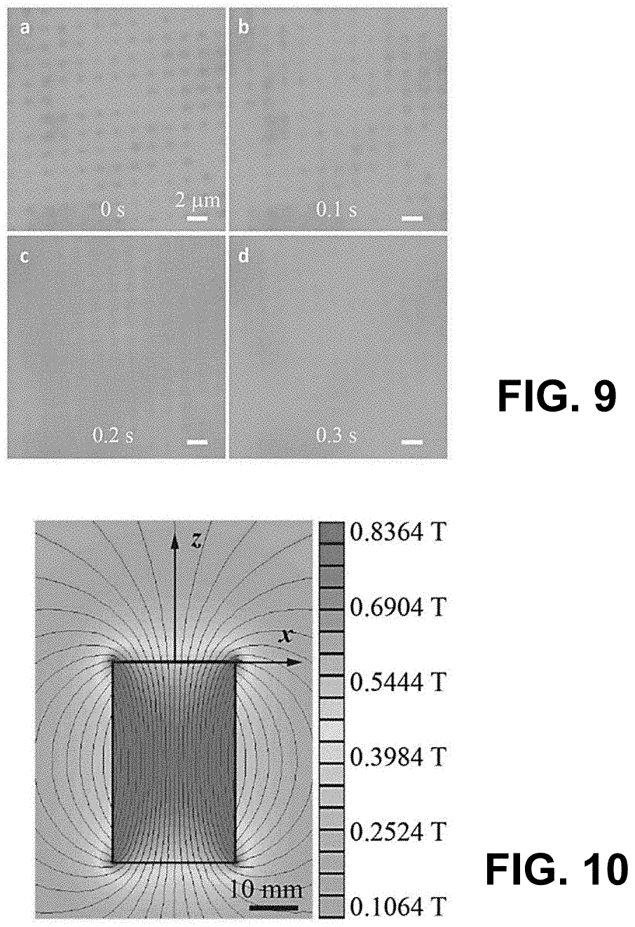

The response time of the self-assembly columns (SACs) disassembly on the FFPDMS magnetic template array has been characterized by analyzing the extracted images from microscopy videos. FIG. 9 shows top-view microscopy images of the disassembly process with the external field is removed taken at (a) 0 s, (b) 0.1 s, (c) 0.2 s and (d) 0.3 s. The scale bars are 2 μm. In the sequence of images, the out-of-plane external field is removed at time t=0 s. Afterward the SACs collapse, and the iron oxide nanoparticles disperse uniformly into the water, resulting in the blurred image of the low-aspect-ratio of the FFPDMS template. The transition is completed within 0.3 s. The assembly and tilting of the SACs occur in shorter amount of time, resulting in less than 0.1 s lag between magnetization and actuation.

### Section E—Magnetization and Magnetic Force of FFPDMS

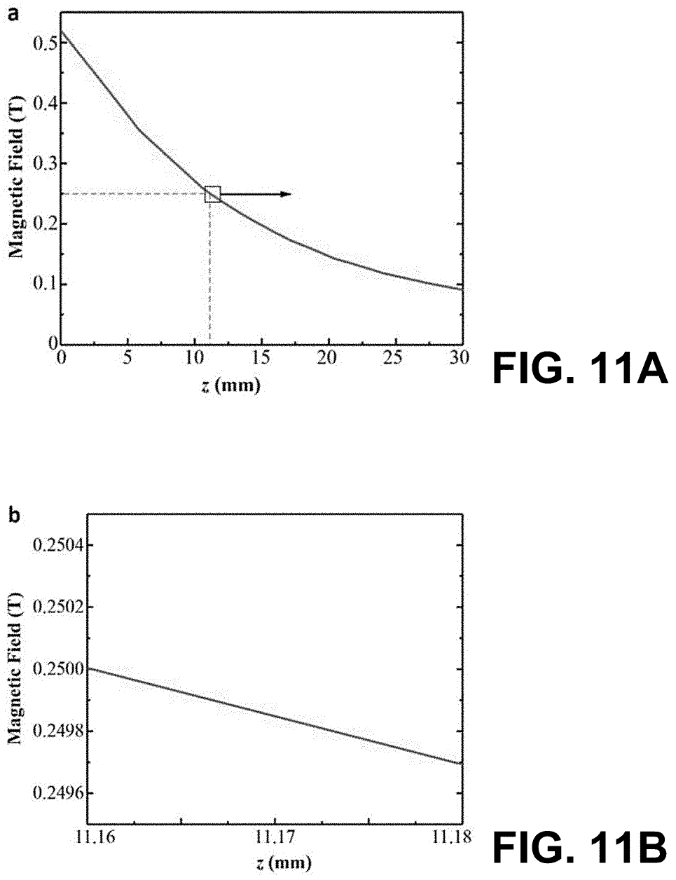

This section describes the simulation of magnetic fields and forces generated when the FFPDMS template is magnetized, which lead to the assembly and anchoring of the SACs. The external field was applied by a cylindrical permanent magnet (e.g., NdFeB, J&K magnetics, diameter 25.4 mm, height 40 mm). The magnetic field distribution contour around the permanent magnet can be numerical calculated using software FEMM. FIG. 10 shows an example of the magnetic field distribution contour of the permanent magnet. Here the field is along the z direction when centered on the axis of the cylindrical magnet, which is extracted from the contour and plotted FIG. 11A, which shows the field from z=0 to z=30 mm. The field decreases as z increases magnetic field distribution contour of the permanent magnet and reaches 0.25 T at z=11.16 mm, which is the distance to the substrate. Particularly, the field at the structure position (from z=11.16 mm to z=11.18 mm) is further extracted. FIG. 11B shows the field from z=11.16 mm to z=11.18 mm, where the fabricated structure is located at. Since the structure is only around 20 μm thick along the z axis, the field gradient is only around 15 T/m. Therefore, the field from the permanent magnet can be regarded as uniform when compared with the local field gradient induced by the magnetic template (4×10⁴ T/m).

When an external field of 0.25 T is applied in the out-of-plane direction, the FFPDMS template generates a periodic field distribution as shown in FIG. 4C. The generated magnetic force F on a single nanoparticle is given by:

F=∇(m·B)=ρV∇(M·B)=ρV∇(MₓBₓ+M_{y}B+M_{z}B_{z}).

Here, m is the magnetic moment vector which is given by m=ρVM. The nanoparticles are approximated as spheres and the estimated volume is

$$V = \frac{4}{3} π \times {( \frac{10 nm}{2} )}^{3} = 5.236 \times {10}^{- 25} {m}^{3} .$$

The mass density is set as ρ=5000 kg/m³. M and B are the vectors of magnetization and magnetic field, the latter including the external field from magnet plus the local field from template, and their dot product is described by components in x, y and z directions, such as Mₓ and Bₓ. Since M does not reach saturation magnetization at 0.25 T external field and is assumed uniformly distributed inside the single iron oxide nanoparticle, M can be expressed as:

$$M = \frac{1}{{μ}_{0}} χ \cdot B .$$

Here, μ₀ is the vacuum magnetic permeability, and the mass susceptibility of iron oxide nanoparticle is χ=1.341×10⁻⁴ m³/kg, which can be approximated as the slope of magnetization curve in FIG. 7A since the magnetization can be regarded as linear from zero to 0.25 T. As a result, the horizontal magnetic force Fₓ applied on iron oxide nanoparticles in ferrofluid can be calculated from the field gradient as:

$${F}_{x} = p V \frac{\partial }{\partial x} ( \frac{1}{{μ}_{0}} χ \cdot B \cdot B ) = 2 \cdot \frac{χ}{{μ}_{0}} \cdot ρ V \cdot ( {B}_{x} \frac{\partial {B}_{x}}{\partial x} + {B}_{z} \frac{\partial {B}_{z}}{\partial x} ) .$$

The Bₓ and B_{z} are extracted from color map at φₘ=0° in FIG. 4C to calculate field gradient component

$$\frac{\partial {B}_{x}}{\partial x} and \frac{\partial {B}_{z}}{\partial x} .$$

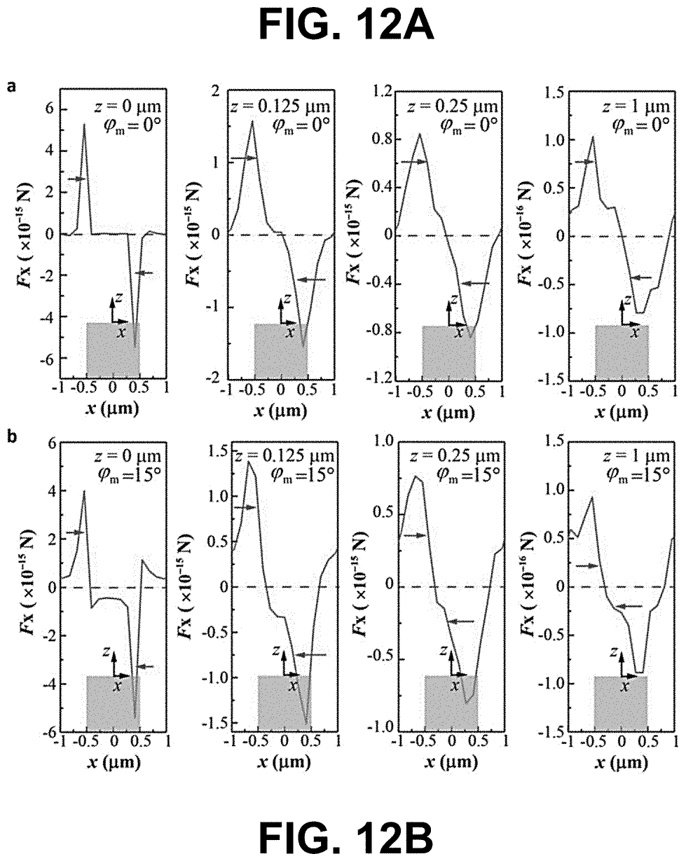

Components in y direction are ignored in this 2D analysis. Finally, the horizontal magnetic forces Fₓ have been worked out and denoted in FIG. 12A, which shows the magnetic forces at z=0 μm, 0.125 μm, 0.25 μm and 1 μm when φₘ=0°. When z=0 μm, Fₓ reaches a peak value of Fₚₑₐₖ=5.28×10⁻¹⁵ N near the edge of FFPDMS pillar at x=±0.5 μm and points toward the center (x=0 μm) where F₀=0 N. This force validates the “anchor” effect that pulls the particles towards the pillar center, shown as the arrows pointing toward the center. The force Fₓ decreases dramatically when z increases. For example, the peak force Fₓ drops down to 8.50×10⁻¹⁶ N at z=0.25 μm, and becomes 1.03×10⁻¹⁶ N at z=1 μm. It rapidly approaches zero as z>1 μm, since the magnetic template generates little field gradient at such distance. This implies the “anchor” effect only exists around the bases of the SACs and will not affect the tilt actuation of the upper portions of the SACs.

Similarly, the curves of Fₓ verses x at φₘ=15° are calculated and displayed in FIG. 12A. Here, the positions of peak force Fₚₑₐₖ and equilibrium center with zero force F₀ all shift about 0.25 μm toward negative direction along x axis, corresponding to the direction of tilted external field. This indicates that when the external field is tilted, not only the upper parts of the SACs will tilt along the external field direction, but also the base of the SACs will shift slightly according to the external field.

Using this model, the peak forces Fₚₑₐₖ verses z at different tilt angles are shown in FIG. 4D to describe the influence of tilt angle φₘ. It can be observed that the peak force Fₚₑₐₖ decreases more and more rapidly as z increases in all cases. This also confirms the working range of “anchor” effect in FIGS. 12A and 12B. In addition, when z<0.25 μm, the Fₚₑₐₖ decreases for higher φₘ. However, when z>0.25 μm, all peak forces tend to be the same despite of different tilt angles. This is also confirmed by the experiments, where to top of the SACs are free to move for any φₘ for effective tilt actuation.

To examine the “anchor effect” in comparison with random motion induced by thermodynamics, the effective force of thermal fluctuation can be simply approximated as the division of the energy by the displacement:

$${F}_{th} = \frac{\frac{1}{2} {k}_{B} T}{Δ x} .$$

Here, ½k_{B}T is the energy in the Brownian motion based on equipartition theorem, and Δx is assumed as the potential displacement of the nanoparticle in the trap, which is assumed as the diameter of the FFPDMS pillar, namely Δx=1 μm. k_{B} is the Boltzmann constant, and T is set as the room temperature (293 K). The effective thermal fluctuation force Fₜₕ is shown as the straight line in FIG. 4D. It indicates that when φₘ 30° and z<0.125 μm, the peak magnetic force Fₚₑₐₖ can overcome the force Fₜₕ, which is consistent with experimental observations. However, at higher z away from the template Fₚₑₐₖ<Fₜₕ, therefore random fluctuation of the SAC top is expected.

### Section F—Field-Induced Nanoparticle Assembly on Non-Magnetic Templates

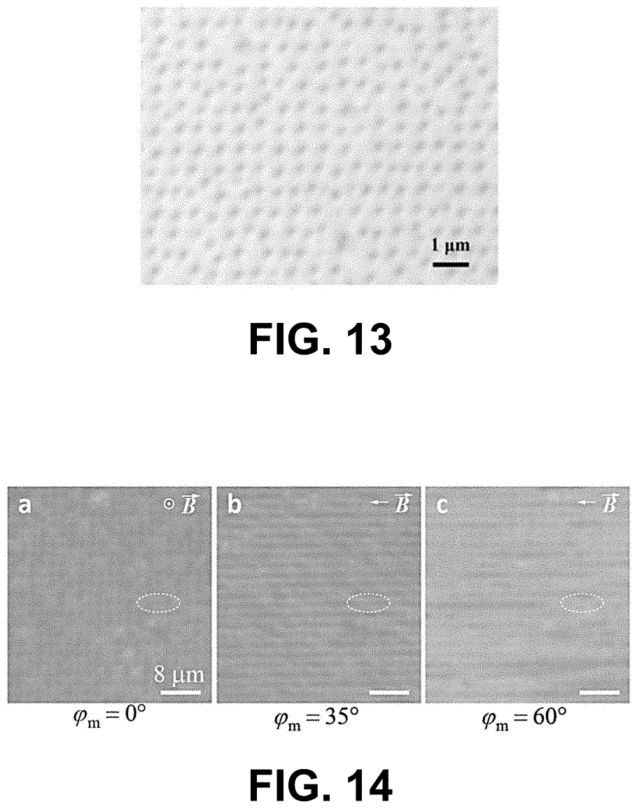

In the previous section the role of the magnetic FFPDMS template is described, which generates a periodic field profile that contributes to the anchoring forces. This section describes the assembly results when a non-magnetic PDMS periodic template was applied to guide field-induced aggregation. The goal is to verify the prediction that the SAC formation is possible on a non-magnetic template. FIG. 13 is an image showing the SACs on PDMS pillar array under out-of-plane magnetic field. While the particle assembles are guided by the PDMS template under an out-of-plane magnetic field, the SACs move around due to thermal fluctuations. Therefore, the particle assembly can be observed to be stable but not “anchored.” When the magnetic field is tilted, the SACs slide from the top of one pillar to another instead of tilting and are no longer perfectly periodic. This can be attributed to the fact that the PDMS nanopillars do not generate a periodic magnetic field profile near the surface. Due to a lack of field gradient, there is no horizontal force to anchor the assembly of the nanoparticles, as discussed in Section E. This demonstrates the importance of “anchor” effect, without which the SACs lack long-range order, fluctuate in the liquid environment, and cannot be tilted by changing the magnetic field. In comparison, the SACs on FFPDMS templates are anchored down to the top of the pillars with rotation about the base as the only degree of freedom.

### Section G—Dynamic Tilt Range of SACs

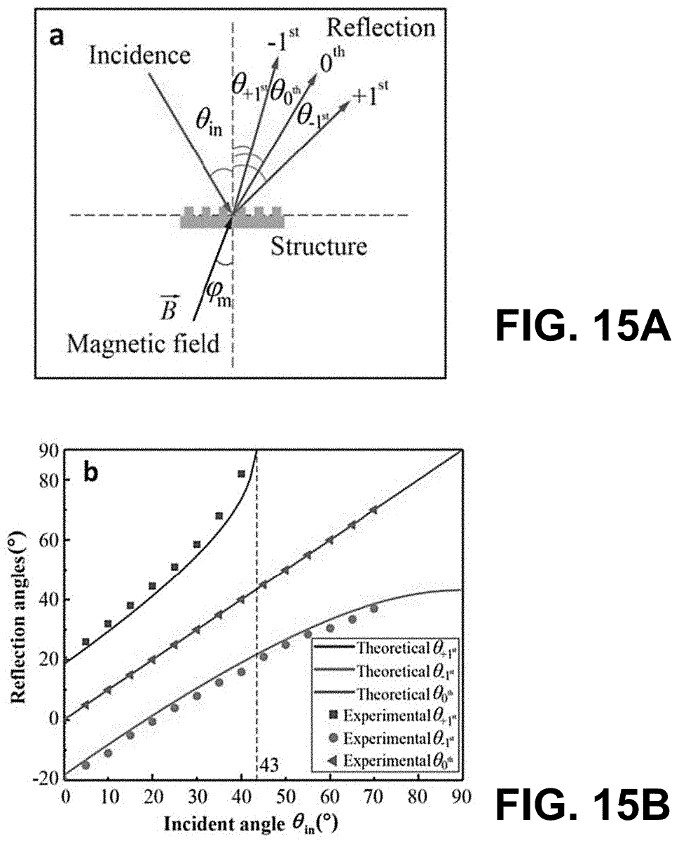

The tilt range of SACs for magnetic actuation is estimated to be φₘ∈[−30°, +30], since larger field tilt angles result in column collapse and extend chain assembly across multiple template pillars. Experimental observation of the collapses of the SACs are depicted in the top view microscope images shown in FIG. 14. The scale bars in all three images are 8 μm. The SACs stand vertically and are stable when φₘ=0°. As the external field angle is increased from 0° to 60°, the SACs remain aligned but start to degrade when φₘ=35° while most of them collapse or disperse into fluid when φₘ=60°, as noted by the dashed ellipses. The remaining SACs tend to form long chains with non-uniformity diameter, evidence of energy imbalance between magnetic and surface energies. The tilted SACs also continuously slide toward the magnet direction. This is attributed to the horizontal shear magnetic forces and field gradient and low anchoring forces at large field angles. As a result, the SACs are not periodic, and the quality is too low to result in tunable optical properties at large tilt angles. Evidence of some assembly degradation initiates at φₘ−30°, leading towards the estimate operation range. This result also confirms the simulation results in FIGS. 4C and 4D.

### Section H—Optical Characterization of Dynamic Iridescent Sample

When a periodic structure is illuminated, the light is diffracted into discrete orders dependent on the structure period and incident wavelength. This can create iridescent effects, where the changes in reflectance spectra at different viewing angles lead to different observed colors. This section describes the operating principle and characterization details for the dynamic color change. For a periodic diffraction grating with period of Λ, the reflection angle θᵢₙ of m-th diffraction order is given by:

Λ·(sin θₘ−sin θᵢₙ)=m·λ.

Here, the period is Λ=2 μm and wavelength is λ=633 nm. The reflection angle θᵢₙ and the incident angle θᵢₙ are both positive, namely they are located at different sides of normal axis. Therefore, the reflection angles of the +1st, −1st, and 0th orders can be described respectively as:

$${θ}_{+ 1} = arcsin ( \frac{633 nm}{2 μm} + sin {θ}_{i n} )$$

$${θ}_{- 1} = arcsin ( \frac{( - 1 ) \times 633 nm}{2 μm} + sin {θ}_{i n} )$$

$${θ}_{0} = {θ}_{i n} .$$

When θᵢₙ=43° which serves as the critical angle, the θ₊₁ is close to 90°. Hence there is no +1st order when the incident angle goes beyond 43°. The ranges of angles for the reflection orders in the operation range are shown in FIGS. 15A and 15B, which show excellent agreement between the optical model and experimental characterization. FIG. 15A is a schematic diagram of incidence and reflection orders. FIG. 15B shows the plot of incident angles and reflection angles for the +1st, −1st and 0th orders, where the solid lines are from theoretical calculations and the indicated points are from experimental measurements.

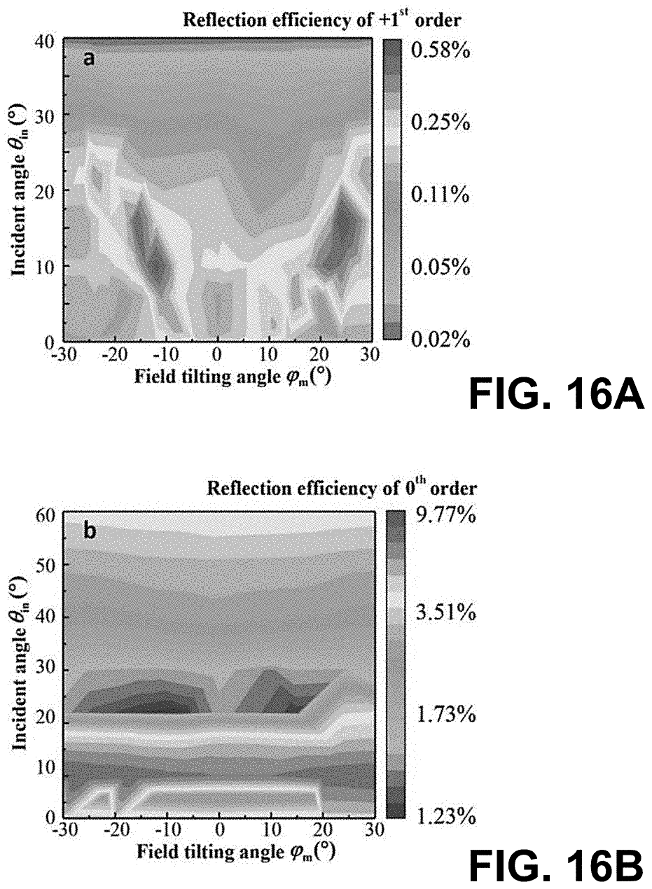

The reflection efficiency contours of the +1st and 0th orders for θᵢₙ=16° are displayed in the 2D contours of FIGS. 16A and 16B, respectively. Similar to the trend of the −1st order, the peak reflection efficiency of the +1st order shows a symmetric trend with respect to the line φₘ=0°. The diffraction independent 0th order does not have peak efficiency trend but has minimum efficiency instead when the incident angle is around 20° to 30°.

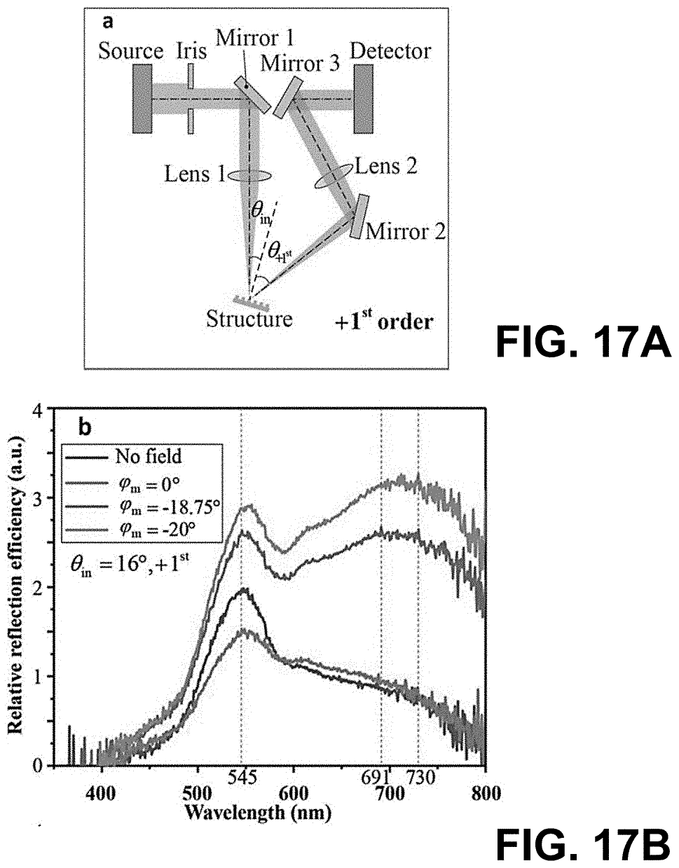

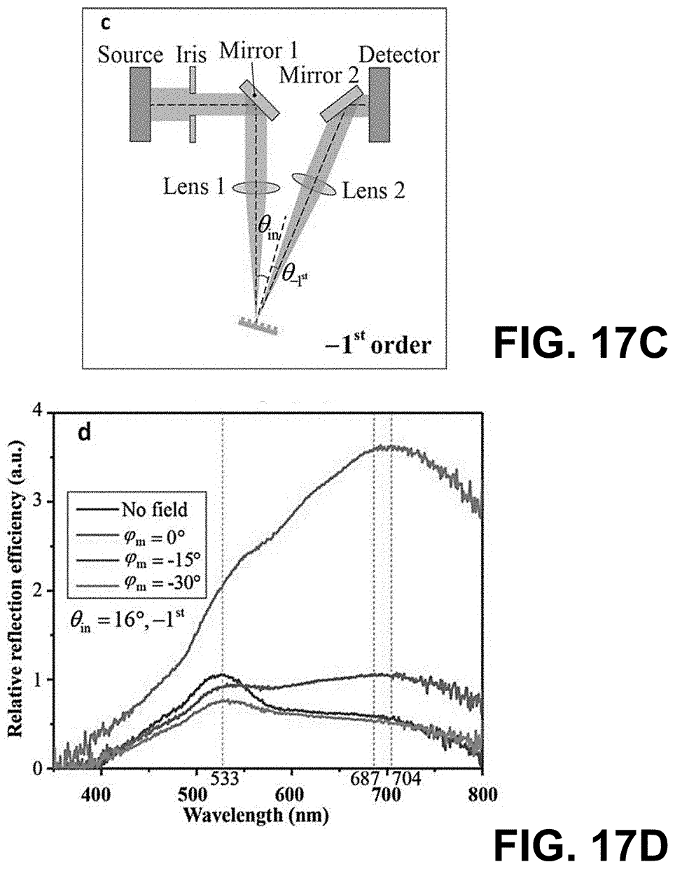

To quantify the iridescence effect and structural color appearance, the reflectance spectra of different diffraction orders with various incident and viewing angles can be characterized using the optical setup shown in FIGS. 17A and 17C. Since the light source and detector are fixed and aligned along a single optical axis in the spectrophotometer, mirrors (e.g., PF10-03-P01, Thorlabs) are applied to alter the light path for different reflected diffraction angles. In addition, the extra optical system increases the optical path length, shifting the position of the waist radius of the Gaussian beam. Therefore, a lens (e.g., LB 1471, Thorlabs) is utilized to guarantee that the position of waist radius is on the surface of the fabricated structure, and another lens (e.g., LB 1471, Thorlabs) is used to minimize the divergence of the light beam.

FIG. 17A is a schematic of the user-customized optical system inside the spectrometer chamber for the +1st order. The dimensions of the experimental setup illustrated in FIG. 17A are: θᵢₙ=16°, θ₊₁ₛₜ=36.31°, the distance between Lens 1 and the structure is 8.3 cm, the distance between the structure and Mirror 2 is 8.5 cm, the distance between Mirror 2 and Lens 2 is 6 cm. FIG. 17C is a schematic of the user-customized optical system inside the spectrometer chamber for the −1st order. The dimensions in FIG. 17B are: θᵢₙ=16°, θ₋₁ₛₜ=−2.34° (the minus sign means θ₋₁ₛₜ is at the same side as θᵢₙ), the distance between Lens 1 and the structure is 8.3 cm, the distance between the structure and Lens 2 is 14.5 cm.

The measured reflectance spectra of the sample at incident angle of 16° and various magnetic field angle φₘ are shown in FIGS. 6A and 6B. Here additional measured spectra of the +1st and −1st orders with negative tilt angles φₘ<0° at θᵢₙ=16° are shown in FIGS. 17B and 17D, respectively. When the external field tilt angle changes from 0° to −20°, the peak wavelength of the +1st order increases from 545 nm to 730 nm with a red shift and a tunability of Δλ/λ₀=+33.9%. On the other hand, when the external magnetic field is tilted from 0° to −30°, the peak wavelength of the −1st order experiences a blue shift from 704 nm to 533 nm with a tenability of Δλ/λ₀=−24.3%.

The shifts in the measured reflectance spectra can be modeled by using a simplified “Venetian blind” model. Since the actuated ferrofluid consists of SACs and water surrounding them, assume that the iron oxide nanoparticles are closed-packed enough inside SACs with concentration of 65% by volume, the effective dielectric constant of the SACs ε_{SAC} can be approximated by Maxwell-Garnett Equation:

$${ɛ}_{SAC} = {ɛ}_{w} \cdot \frac{[ 2 {δ}_{m} ( {ɛ}_{m} - {ɛ}_{w} ) + {ɛ}_{m} + 2 {ɛ}_{w} ]}{[ 2 {ɛ}_{w} + {ɛ}_{m} + {δ}_{m} ( {ɛ}_{w} - {ɛ}_{m} ) ]} .$$

Here, ε_{w} is the dielectric constant of water, εₘ is the dielectric constant of magnetite nanoparticles, and the volume fraction of nanoparticles is δₘ=0.65. As the refractive index n can be expressed by dielectric constant (or relative permittivity) εᵣ and relative permeability μᵣ:

$$n = \sqrt{{ɛ}_{r} {μ}_{r}} = \sqrt{\frac{ɛμ}{{ɛ}_{0} {μ}_{0}}} .$$

Here, the ε and ε₀ are the permittivity of a specific medium and the vacuum permittivity, respectively; while μ and μ₀ are the permeability of a specific medium and the free space permeability, respectively.

The refractive indices of iron oxide nanoparticle and water are nₘ=2.34 and n_{w}=1.33, respectively, and the dielectric constants of iron oxide nanoparticle and water are εₘ=5.48 and ε_{w}=1.77, respectively. Particularly, the relative permeability of iron oxide nanoparticle is close to 1 at visible frequencies, which can be verified by μₘ=nₘ²/εₘ. Therefore, the refractive index of the SACs can be calculated as:

$${n}_{SAC} = \sqrt{{n}_{w}^{2} \cdot \frac{2 {δ}_{m} ( {n}_{m}^{2} - {n}_{w}^{2} ) + {n}_{m}^{2} + 2 {n}_{w}^{2}}{{n}_{m}^{2} + 2 {n}_{w}^{2} + {δ}_{m} ( {n}_{w}^{2} - {n}_{m}^{2} )}} .$$

Finally the n_{SAC}=1.92 is obtained from the calculation.

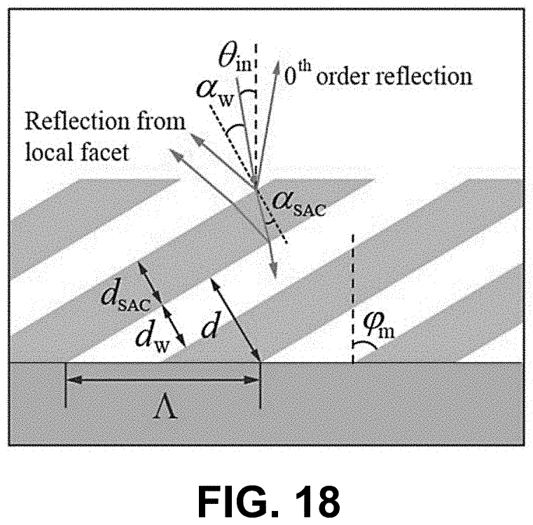

FIG. 18 is a schematic illustrating an example of a multilayer reflector. d_{w} and d_{SAC} are the thicknesses of the water layer and the SAC respectively along the facet normal of SACs. α_{w} and α_{SAC} are the refraction angles inside the water layer and the SAC respectively to the facet normal of SACs. Based on the multilayer reflector of FIG. 18, the peak wavelength λ is given by:

$$\begin{matrix}λ = \frac{2}{m} ( {d}_{SAC} \sqrt{{n}_{SAC}^{2} - {n}_{w}^{2} {sin}^{2} ( {α}_{w} )} + {d}_{w} {n}_{w} cos ( {α}_{w} ) ) \\ = \frac{1}{m} Λ cos ( {ϕ}_{m} ) ( \sqrt{{n}_{SAC}^{2} - {n}_{w}^{2} {cos}^{2} ( {θ}_{i n} + {ϕ}_{m} )} + {n}_{w} sin ( {θ}_{i n} + {ϕ}_{m} ) ) .\end{matrix}$$

Here the m is the order of the multilayer reflector. d_{w} and d_{SAC} are the thicknesses of the water layer and the SAC, respectively, along the facet normal of SACs. Based on the concentration of the SACs, the thicknesses can be approximated to be the same, resulting in d_{w}=d_{SAC}=½d=½Λcos (φm)·α_{w}, where α_{w} and α_{SAC} are the refraction angles inside the water layer and the SAC, respectively, defined relative to the facet normal of SACs. Assuming the incident light hits SAC first, then α_{w}=90°−θᵢₙ−φₘ. Based on Snell's law, we have: n_{w} sin(α_{w})=n_{SAC} sin(α_{SAC}). Therefore, the peak wavelength A can be expressed in terms of the field tilt angle φₘ:

$$λ = \frac{2}{m} ( {n}_{w} {d}_{w} cos ( {α}_{w} ) + {n}_{SAC} {d}_{SAC} cos ( {α}_{SAC} ) ) .$$

For incident angle θᵢₙ=16°, structure period Λ=2 μm, and m=6, the theoretical model can be calculated and compared with the measured spectrometry peak wavelength of the −1st order, as shown in FIG. 6D.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about y”.

Therefore, at least the following is claimed:

1. A magnetically actuated surface, comprising:
an array of magnetic nanopillars; and
a ferrofluid sealed in a microfluidic channel over the array of magnetic nanopillars.

2. The magnetically actuated surface of claim 1, wherein the array is a 2D array of magnetic nanopillars.

3. The magnetically actuated surface of claim 1, wherein the array of magnetic nanopillars is formed from ferrofluid polydimethylsiloxane (FFPDMS).

4. The magnetically actuated surface of claim 1, wherein the ferrofluid comprises iron oxide nanoparticles.

5. The magnetically actuated surface of claim 1, wherein the ferrofluid is sealed in the microfluidic channel by a polydimethylsiloxane (PDMS) layer.

6. The magnetically actuated surface of claim 1, comprising a magnetic field source that directs a magnetic field through the ferrofluid in the microfluidic channel thereby forming self-assembled columns (SACs) of magnetic particles on corresponding magnetic nanopillars of the array of magnetic nanopillars.

7. The magnetically actuated surface of claim 6, wherein orientation of the SACs is based upon a direction of the magnetic field.

8. The magnetically actuated surface of claim 7, wherein the orientation of the SACs changes in response to a change in a field tilting angle of the magnetic field.

9. The magnetically actuated surface of claim 8, wherein the SACs pivot about an end of the corresponding magnetic nanopillars.

10. The magnetically actuated surface of claim 7, wherein the field tilting angle is about 30 degrees or less.

11. The magnetically actuated surface of claim 6, wherein the magnetic field source is a permanent magnet.

12. The magnetically actuated surface of claim 6, wherein the magnetic field source comprises integrated electromagnets adjacent to the array of magnetic nanopillars.

13. The magnetically actuated surface of claim 12, wherein the integrated electromagnets are independently controllable providing a programmable surface.

14. A method for forming a magnetically actuated surface, comprising:
generating a 2D periodic array of recesses in a photoresist layer;
generating a nanopillar template using the 2D periodic array of recesses in the photoresist layer;
forming a microfluidic channel between the nanopillar template and a polydimethylsiloxane (PDMS) layer; and
filling the microfluidic channel with a ferrofluid comprising magnetic nanoparticles in a fluid medium.

15. The method of claim 14, wherein the ferrofluid is sealed within the microfluidic channel.

16. The method of claim 14, wherein the nanopillar template is a ferrofluid polydimethylsiloxane (FFPDMS) template.

17. The method of claim 14, wherein the magnetic particles comprise iron oxide nanoparticles.

18. The method of claim 17, wherein the fluid medium comprises deionized water.

19. The method of claim 14, wherein the 2D periodic array of recesses is formed in the photoresist layer using interference lithography.

20. The method of claim 19, wherein the nanopillar template is disposed on a substrate.
